(19) United States
(12) Patent Application Publication
(10) Pub. No.: US 2013/0183922 A1
(43) Pub. Date: Jul. 18, 2013

(54) Method For Determining When A Large Crowd Gathers Based Upon Mobile Unit Registration Messages

(71) Applicants: Tim J. Olker, Warrenville, IL (US); Leslie J. Williams, Naperville, IL (US)

(72) Inventors: Tim J. Olker, Warrenville, IL (US); Leslie J. Williams, Naperville, IL (US)

(21) Appl. No.: 13/349,687

(22) Filed: Jan. 13, 2012

(51) Int. Cl. H04W 4/22; H04W 60/00

(52) U.S. Cl. 455/404.2; 455/435.1

(57) ABSTRACT

A plurality of registration messages are received at a base station from a plurality of mobile units. The base station collects these registration messages for a predetermined period of time. At the end of the predetermined period of time, the base station sends the registration messages, or a summary of the registration messages, to a wireless network. The wireless network examines the registration messages to determine if the number of registration messages received for a predefined geographic area exceeds a predetermined threshold. If so, the wireless network sends a crowd information update message to a law enforcement agency if the plurality of registration message exceed a predetermined threshold.

### FIELD OF THE INVENTION

The present invention relates generally to communication systems, and more particularly to processing requests for lawful interceptions.

### BACKGROUND OF THE INVENTION

Currently law enforcement agencies are required to monitor and ensure safety at all times, and especially when large crowds gather.

Currently law enforcement agencies obtain indications of large crowds gathering either by witnessing them in person or by receiving calls from witnesses to the events. It is extremely difficult for the law enforcement agents to be at all places at one time. It is also difficult for law enforcement agencies to know which calls they are receiving are accurate and also to have the manpower to receive and process the number of calls received.

Therefore, a need exists for a way of determining when large crowds gather without having to visually sight the crowds in person.

### BRIEF SUMMARY OF THE INVENTION

An exemplary embodiment of the present invention relates to a method and system for notifying governmental agencies of rapid population changes. For example, an unusually large crowd forming of an unusual absence of people from a place where they would be expected.

While in the US and in many other countries it is not legal to track a phone without a court order, the ability to anonymize the locations of groups of cell phones would allow government agencies the ability to track the presence or absence of large numbers of cellular phones in an area.

An exemplary embodiment allows a representative of the government to request surveillance of an area and to be notified if there is a large change in the presence of cellular phones in the area. This would trigger the wireless network to send a Lawful Interception (LI) message to the government's Law Enforcement Agency (LEA) with information of the approximate size of the group and the general geographical area of the group.

The wireless network determines when to send a message based on a regular audit of page responses/requests for service from mobile units received at each base station. A set of thresholds is used for each geographic area covered by the wireless network. This would set the normal range of mobile units in an area. For example, a sports stadium could normally be expected to have a large number of people in a tight geographical area at predetermined times.

An exemplary embodiment also is useful for disaster response, where the absence of registration messages indicates that a specific area does not have many people in it, which could be the result of a disaster.

An exemplary embodiment comprises a government dealing with protests. Protesters are using mobile devices to access social networks to organize themselves. In a time such as this the government could place a court order to track crowds. The court order would be distributed to the cellular providers who in turn return information where a surge in cellular phone activity is present. This in turn allows government agencies to be aware of developing situations and be able make informed decisions when responding.

### BRIEF DESCRIPTION OF THE SEVERAL VIEWS OF THE DRAWINGS

FIG. 1 depict a wireless network in accordance with an exemplary embodiment of the present invention.

FIG. 2 depicts a flow diagram in accordance with an exemplary embodiment of the present invention.

### DETAILED DESCRIPTION OF THE INVENTION

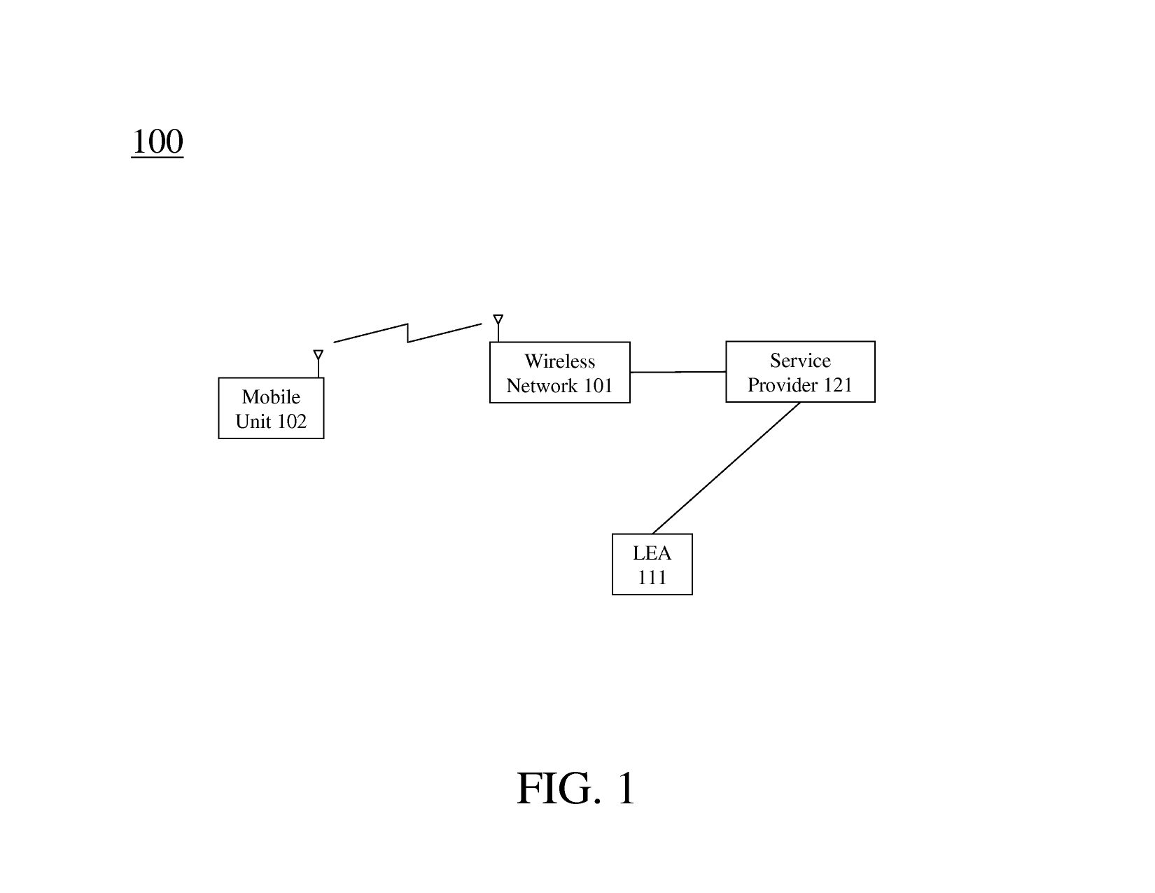

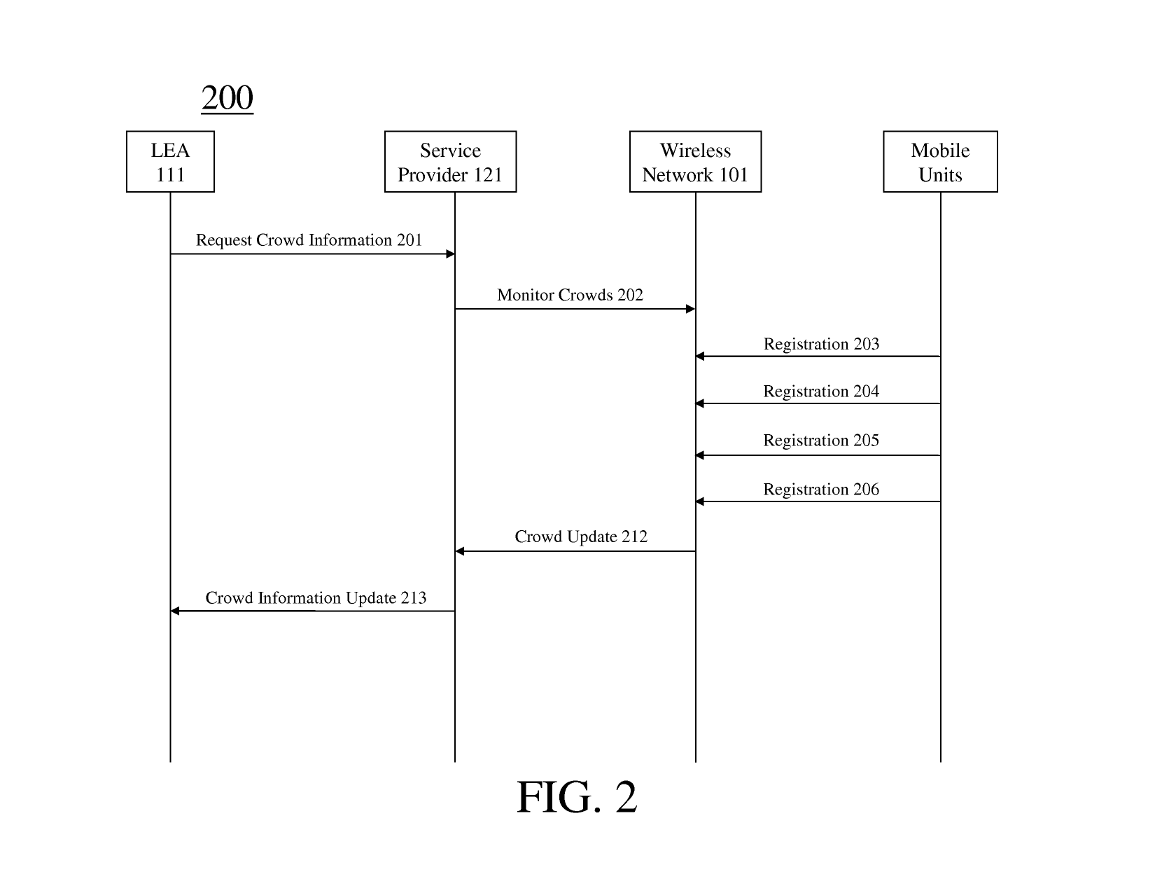

An exemplary embodiment of the present invention can be better understood with reference to FIGS. 1 and 2. FIG. 1 depicts a communication network 100 including a wireless network 101, mobile unit 102, law enforcement agency 111, and service provider 121.

In accordance with an exemplary embodiment, wireless network 101 comprises a plurality of base stations and other network elements that allow wireless network 101 to process wireless communications. Wireless network 101 communicates with mobile unit 102 via any of a plurality of air interfaces.

Mobile unit 102 is a mobile device that communicates with wireless network 101, preferably using a wireless air interface. Although only one mobile unit is depicted in FIG. 1 for clarity, it should be understood that communication network 100 services a plurality of mobile units that are not shown.

Law enforcement agency (LEA) 111 is an agency that is legally authorized to perform surveillance activities. For example, LEA 111 can be the Federal Bureau of Investigation (FBI), state police departments, or local police departments.

Service provider 121 provides access and service to mobile units to utilize wireless network 101. Service provider 121 controls wireless network 101 and also in interconnected with LEA 111.

FIG. 2 depicts a flow diagram 200 in accordance with an exemplary embodiment of the present invention. In accordance with an exemplary embodiment, a law enforcement agency would request to be notified if there is any unusual surge in the number of mobile units located in an area that surpasses the usual number of mobile units in that area. For example, this could occur if there is a natural disaster, a terrorist attack, a protest, mob action, or any other situation in which a large number of people gather unexpectedly.

LEA 111 sends request crowd information message 201 to service provider 121. Request crowd information message 201 preferably includes a geographic location to be monitored for crowd activity. Request crowd information message 201 can include the length of time that the request should be implemented.

Service provider 121 sends monitor crowds message 202 to wireless network 101. Monitor crowds message 202 preferably includes the geographic location to be monitored for crowd activity and the length of time that the request should be implemented. Service provider 121 may convert the geographic location received from LEA 111 into cell sectors. Alternately, wireless network 101 can convert the requested geographic location into matching cell sectors that match the geographic location requested.

After receiving monitor crowds message 202, wireless network 101 receives registration message 203 from a mobile unit. Cellular phones are in constant contact with a cellular network, even when not on a call. Registration message 203 can be any message sent by a mobile unit to wireless network 101, such as registration message, call initiation message, or any other message sent from a mobile unit to wireless network 101.

In accordance with an exemplary embodiment, wireless network 101 receives registration message 204 from a mobile unit different than the mobile unit that sent registration message 203. Registration message 204 is similar to registration message 203.

Wireless network 101 receives registration message 205 from a mobile unit that is different from the first two mobile units that sent messages to wireless network 101.

Wireless network 101 continues to receive registration messages, such as registration message 206, from other mobile units.

Wireless network 101 monitors registration activity on a predetermined basis, preferably by counting the number of messages received from unique mobile units. In an exemplary embodiment, the predetermined basis is five minutes. In an exemplary embodiment, wireless network 101 sends crowd update message 212 to service provider 121 if the number of registration messages received from unique mobile units within the predetermined time period exceeds the predetermined threshold. In an alternate exemplary embodiment, wireless network 101 sends crowd update message 212 to service provider 121 upon expiration of a timer. Crowd update message preferably includes the number of registration messages received, the location of the received registration messages, and the time at which each message was received.

Service provider 121 determines if the amount of activity exceeds the normal amount of activity for that location and time of day. If so, service provider 121 sends crowd information update message 213 to LEA 111. Information update message 213 preferably includes the approximate number of people in the group and the location of the group.

LEA 111 can then use the information from crowd information update message 111 to determine if police support or crowd control is needed in the area identified. This is done without knowing the exact identity of any of the people or mobile units located at the location.

While this invention has been described in terms of certain examples thereof, it is not intended that it be limited to the above description, but rather only to the extent set forth in the claims that follow.

We claim:

1. A method for determining when a large crowd gathers, the method comprising:
receiving a plurality of registration messages from a plurality of mobile units, wherein the plurality of registration messages are received within a predefined period of time, and wherein the plurality of mobile units are located within a predefined geographic area; and
sending a crowd information update message if the plurality of registration message exceed a predetermined threshold.

2. A method for determining when a large crowd gathers in accordance with claim 1, wherein the predefined geographic area correlates to a cell sector.

3. A method for determining when a large crowd gathers in accordance with claim 1, wherein the plurality of registration messages comprises a call initiation message.

4. A method for determining when a large crowd gathers in accordance with claim 1, wherein the plurality of registration messages comprises a power on message.

5. A method for determining when a large crowd gathers in accordance with claim 1, wherein the crowd information message includes the number of registration messages received.

6. A method for determining when a large crowd gathers in accordance with claim 1, wherein the crowd information message includes the location of the received registration messages.

7. A method for determining when a large crowd gathers in accordance with claim 1, wherein the crowd information message includes the time at which each of the plurality of registration messages was received.

8. A method for determining when a large crowd gathers in accordance with claim 1, wherein the predetermined threshold is determined, at least in part, based upon the time of day.

9. A method for determining when a large crowd gathers in accordance with claim 1, wherein the predetermined threshold is determined, at least in part, based upon a normal amount of registration message activity.

10. A method for determining when a large crowd gathers in accordance with claim 1, wherein the predetermined threshold is determined, at least in part, based upon the predefined geographic area.

11. A method for determining when a large crowd gathers in accordance with claim 1, wherein the step of sending a crowd information update message comprises sending the crowd information update message to a law enforcement agency.

12. A method for determining when a large crowd gathers in accordance with claim 1, wherein the crowd information update message comprises an approximate number of people in the group.

13. A method for determining when a large crowd gathers in accordance with claim 1, wherein the crowd information update message comprises the location of the group.
